(19) United States
(12) Patent Application Publication
(10) Pub. No.: US 2008/0180030 A1
(43) Pub. Date: Jul. 31, 2008

(54) PLASMA PROCESSING APPARATUS

(76) Inventors: Tsutomu Tetsuka, Kasumigaura (JP); Tadayoshi Kawaguchi, Kudamatsu (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/680,011

(22) Filed: Feb. 28, 2007

(30) Foreign Application Priority Data
Jan. 31, 2007 (JP) 2007-020304

(51) Int. Cl. H05H 1/00

(52) U.S. Cl. 315/111.41

(57) ABSTRACT

A plasma processing apparatus includes a vacuum container, a processing chamber arranged in the vacuum container and supplied with a processing gas, a holding electrode arranged in the processing chamber for holding a sample to be processed, on the upper surface thereof, an electric field supply unit for supplying an electric field and a magnetic field supply unit for supplying a magnetic field to form the plasma in the space above the holding electrode in the processing chamber, and a grounded wall member making up the inner wall, substantially in the shape of a truncated cone, of the processing chamber above the holding electrode.

### BACKGROUND OF THE INVENTION

This invention relates to a plasma processing apparatus and a plasma processing method, or in particular to a plasma processing apparatus for generating the plasma inside a processing chamber in a vacuum container and forming an electric field by the high frequency power on the surface of a substrate-like sample such as a semiconductor element while etching and forming a film on the sample surface.

In recent years, the precision of various semiconductor elements of the microcomputer, etc. has increased to such an extent that a uniform, stable ultra fine processing technology has come to assume an increasingly important role in the fabrication of semiconductor elements. Also, in view of the fact that the impurity elements intruding into the semiconductor elements during the fabrication process have an adverse effect on the semiconductor performance, demand has increased more and more for reducing the impurities and fine foreign matter generated in the processing apparatus.

The plasma processing apparatus, which makes it possible to form a film and the dry etching of fine semiconductor elements utilizing the effects of active molecules and reactive ions generated in low gas-pressure discharge, has become indispensable for many fabrication processes. Of all the plasma processing apparatuses, the magnetized plasma processing apparatus using a magnetic field for generating and transporting a plasma, which is capable of stable discharge under a low gas pressure and high in the plasma distribution controllability by the magnetic field, is considered effective for high-accuracy processing.

This conventional plasma processing apparatus is either of the type in which a processing chamber and a plasma generating chamber using the microwave are separated from each other or the type in which the plasma is generated in the processing chamber. The apparatus in which the plasma generating chamber and the processing chamber are separated from each other is disclosed in JP-A-7-94297.

According to this related art, the plasma is generated efficiently utilizing the electron cyclotron resonance (ECR). In this related art, the vacuum container for executing the plasma processing includes a plasma generating chamber for generating the plasma and a processing chamber formed immediately under the plasma generating chamber for processing a sample mounted therein. The plasma generating chamber has a side wall formed of an aluminum alloy, etc. and an upper surface formed with a quartz plate to seal an microwave inlet in vacuum.

A waveguide for propagating the microwave is connected to the microwave inlet open in communication with the interior of the plasma generating chamber, and the output from a microwave oscillator is radiated into the plasma generating chamber through the microwave inlet. Also, the plasma generating chamber is connected with a gas pipe by which the discharge gas required to form the plasma is supplied. Further, a coil for generating the magnetic field required to be applied for plasma generation is arranged on the outer periphery of the plasma generating chamber.

In the case where the plasma is processed according to this related art, the plasma generating chamber and the plasma processing chamber are evacuated to a predetermined pressure and set to a predetermined gas pressure by supplying a discharge gas thereto. Next, the current is supplied to the magnetic field coil and the magnetic field strength is adjusted to such an extent that the ECR resonance occurs in the plasma generating chamber. In the case where the microwave (frequency 2.45 GHz) is used, the ECR resonance occurs with the magnetic field strength of 875 Gauss. Also, the plasma generating chamber functions as a cavity resonator for the microwave, and therefore, upon application of the microwave to the plasma generating chamber through the microwave inlet, the plasma is generated with high efficiency at the magnetic field position where the ECR resonance occurs.

The plasma generated in the plasma generating chamber is restricted by the magnetic field applied from the magnetic field coil, and dispersed and moved to the adjacent processing chamber downward mainly along the magnetic lines of force thereby to process the surface of the sample to be processed. With this processing apparatus, in order to reduce the impurities and fine foreign matter generated in the process, the side wall of the plasma generating chamber is formed substantially parallel to the direction of the magnetic lines of force. In this way, the angle at which the plasma flows into the inner surface of the side wall is considerably reduced thereby to reduce the sputtering of the wall surface by the charged particles in the plasma.

The sputtering by the charged particles reaches the maximum rate in the case where the angle of incidence to the wall surface is 30 to 60 degrees, and with the decrease in the angle of incidence, the sputter rate is known to decrease. In view of this, according to this related art, the wall of the plasma generating chamber is formed parallel to the magnetic lines of force. Thus, the angle of incidence is decreased and the sputter rate is maintained low, so that the particle generation from the wall member is suppressed thereby to reduce the particle application to and the contamination of the sample.

As the related art to generate the plasma in the plasma processing chamber, the plasma processing apparatus disclosed by, for example, JP-A-8-138890 is known. In the plasma processing apparatus disclosed in JP-A-8-138890, an opening to introduce the microwave is formed in the upper part of the processing chamber, and a wafer holding electrode in the lower part thereof. In the processing chamber, a discharge block in contact with the plasma is arranged. The inner surface of the discharge block is enlarged downward in tapered form at 10 to 20 degrees to the axial direction, and a plurality of gas vents are uniformly formed along the circumference on the upper inner surface.

The taper of the inner surface of the discharge block is for uniformly processing the target substrate by uniformly expanding the plasma, and small in angle to prevent the electric field mode from changing or the other electric field mode from increasing and intruding while the microwave proceeds in the discharge block. The inner surface of the discharge block is formed of a plasma-resistant material (such as alumina, mullite or quartz).

In the plasma processing apparatus disclosed in JP-A-8-138890, the impurities and fine foreign matter generated in the processing apparatus are reduced by use of the plasma-resistant material thereby to suppress the consumption of the wall material which causes the foreign matter and impurities. In recent years, however, the requirement for preventing the intrusion of impurities such as heavy metal into the sample to be processed has gradually increased to such an extent that even the intrusion of the main constituent elements such as aluminum and minor heavy metal contents (Fe, Mg, etc.) of alumina and mullite making up the plasma-resistant material is no longer negligible, and therefore, the consumption of the plasma-resistant material is also required to be suppressed.

The main cause of the consumption of the wall of the plasma generating chamber and the processing chamber is considered to be the ion sputter due to ions and electrons flowing into the part in contact with the plasma. As described in JP-A-7-94297 and JP-A-8-138890, the magnetized plasma or magnetically enhanced plasma is generated in the neighborhood of the ECR resonance adjusted by the magnetic field strength, and the plasma thus generated flows into the processing area along the magnetic lines of force while being restricted by the magnetic field.

With regard to the restriction of electrons and ions in the plasma by the magnetic field, as described in Francis. F. Chen “Introduction to Plasma Physics”, 1997, p. 134, the mobility and the dispersion coefficient of the charged particles in the magnetic field are expressed by Equations (1) and (2) below.

Mobility in the direction along magnetic lines of force:

μ⊥=μ/(1+(ω_{c}/ν)²) (1)

Dispersion coefficient in the direction along magnetic lines of force:

D⊥=D/(1+(ω_{c}/ν)²) (2)

where the direction across the magnetic lines of force is indicated by ⊥ and the direction along the magnetic lines of force by the absence of the affix ⊥, and where ω_{c} is the cyclotron angular speed (=qB/m) and ν the collision frequency with the neutral gas.

Equations (1) and (2) indicate that the motion in the direction across the magnetic lines of force is suppressed by the amount equivalent to the coefficient (1+(ω_{c}/ν)²). Estimation of Equations (1) and (2) assuming the magnetic field of 100 Gauss, the gas pressure of 1 Pa and the electron temperature of 4 eV as the apparatus parameters of an ordinary magnetized plasma processing apparatus or a magnetically enhanced plasma processing apparatus leads to the cyclotron frequency ω_{c}=1.8×10⁹(1/s), the collision frequency ν=2.4×10⁷ (1/s) and the coefficient (1+(ω_{c}/ν)²)=5200. According to this estimation, therefore, the mobility and dispersion are small in the direction across the magnetic lines of force, and the electrons and ions are considered to be transported mainly in the direction along the magnetic lines of force. With regard to the damage to the inner wall of the processing chamber by the influent plasma, therefore, the plasma flow along the magnetic lines of force is required to be taken into account.

Another cause of damage to the wall of the processing chamber is the high frequency power applied to the sample to be processed. Application of high frequency power to the sample generates a potential difference of several tens to several hundreds of volts in the sheath formed on the surface of the particular sample, and when the ions entering the sample pass through the sheath, the acceleration energy is adjusted by the electric field and the sample surface reaction can be controlled.

In the process, the potential difference due to the high-frequency power is generated not only in the sheath on the front surface of the sample but also in the sheath on the surface of the processing chamber constituting the opposite earth, and the wall is sputtered by accelerated ions. The potential difference generated on the inner wall of the processing chamber is dependent simply on the relative area ratio between the sample and the wall of the processing chamber and expressed by Equation (3) below.

Va/Vb=(Ab/Aa)^{5/2} (3)

where Vb is the potential difference of the sheath on the sample, Ab the area of the sample, Va the potential difference of the sheath on the wall of the processing chamber, and Aa the wall area.

This knowledge is described in M. A. Lieberman, A. J. Lichtenberg: “PRINCIPLES OF PLASMA DISCHARGES AND MATERIALS PROCESSING”, JON WILEY & SONS, INC. p. 370. It is understood from Equation (3) that the potential difference generated in the sheath on the wall of the processing chamber is inversely proportional to the area ratio between the sample and the wall, and by enlarging the wall area, the potential difference on the wall is decreased to reduce the damage due to the ion sputter.

Also, in the case where the high frequency power applied to the sample propagates to the wall of the processing chamber across the magnetic lines of force, the motion of electrons is restricted by the magnetic field as indicated by Equation (1). In the direction along the magnetic lines of force, the electrons can easily move, and therefore, the potential difference due to the high frequency power is small as it offsets the electric field. In the direction across the magnetic lines of force, on the other hand, the electrons can not easily move, and therefore, the potential difference between the magnetic lines of force tends to increase. As a result, the shorter the distance across the magnetic lines of force from the sample impressed with the high frequency power, the larger the potential difference. Thus, the sheath voltage of the particular part of the wall of the processing chamber increases thereby to increase the damage due to the ion sputter.

### SUMMARY OF THE INVENTION

The cited reference Francis. F. Chen “Introduction to Plasma Physics” takes the sputtering by the ions moving in the direction along the magnetic forces of line into consideration, but not the case in which the sample is controlled while applying the magnetic field due to the high-frequency power to the sample. Also, the electric field caused by the high-frequency power applied to the sample is liable to propagate in the direction along the magnetic lines of force due to the large resistance in the direction across the magnetic lines of force in the magnetic field formed in the processing chamber. The part constituting the earth of the high-frequency power, therefore, is such that the inner wall surface in the lower part of the processing chamber having a short distance across the magnetic lines of force from the sample and the outer peripheral portion of the microwave inlet at the upper end of the plasma generating chamber mainly act as an earth electrode and constitute a surface area by way of which the high-frequency power flows in.

As described above, in the area where the high-frequency power flows unevenly in a great amount, the ion acceleration on the sheath of the wall surface is enhance to such an extent that the damage to the inner wall due to the ion sputter is also accelerated. Also, the area of the side wall (side wall of the plasma generating chamber) in contact with the plasma is not sufficiently secured, and therefore, upon application of the high-frequency power, ions in the sheath formed in the plasma generating chamber are accelerated, thereby increasing the wall damage due to the ion sputter. The resulting problem is that the intervals at which these members are replaced are shortened and the damage to the wall due to the ion sputter increases. This problem is not taken into consideration by Francis. F. Chen “Introduction to Plasma Physics”. Also, Francis. F. Chen “Introduction to Plasma Physics” presupposes the generation of the high-density plasma, and poses the problem that an attempt to carry out the low-density plasma processing would disperse the microwave unevenly in the sample chamber with the plasma density of not higher than about 1×10¹¹ cm⁻³ and adversely affect the processing efficiency.

In the related art described in A. J. Lichtenberg: “PRINCIPLES OF PLASMA DISCHARGES AND MATERIALS PROCESSING”, JON WILEY & SONS, INC., on the other hand, the inner wall of the processing chamber is enlarged in taper to optimize the microwave mode, and therefore, in the case where the electric field due to the high-frequency power is applied to the sample, the magnetic lines of force are not parallel to the tapered side wall. At the position of the side wall short in the distance across the magnetic field from the sample, therefore, the potential difference is increased, and the damage by ion sputtering is locally concentrated. Also, the protective material (alumina, mullite, quartz, etc.) used on the inside of the inner wall of the processing chamber to prevent the etching thereof by the active species in the plasma hampers the propagation of the high frequency power applied to the sample and the side wall fails to function as the earth sufficiently. Thus, the effective earth area cannot be sufficiently secured, and the improvement in the performance including the processing rate and the anisotropy of the process due to the application of the high-frequency power is adversely affected. Further, these problems including the damage by the ion sputtering to the part not protected by the protective material are not sufficiently taken into consideration by the cited reference A. J. Lichtenberg: “PRINCIPLES OF PLASMA DISCHARGES AND MATERIALS PROCESSING”, JON WILEY & SONS, INC.

Accordingly, it is an object of this invention to provide a plasma processing apparatus which overcomes the problems described in the aforementioned related art.

Another object of the invention is to provide a plasma processing apparatus in which the damage to the processing chamber causing the contamination of the sample and the intrusion of foreign matter is suppressed and the availability is increased.

In order to achieve the objects described above, according to an aspect of the invention, there is provided a plasma processing apparatus comprising a vacuum container, a processing chamber formed in the vacuum container and supplied with a gas, a holding electrode arranged in the processing chamber for holding the sample to be processed, an antenna and a radiation port for radiating the radio wave of UHF or VHF band of not higher than 500 MHz into the processing chamber, and a magnetic field coil for forming a magnetic field in the processing chamber, wherein a tilted inner wall surface member having a trapezoidal cross section surrounded by the antenna and the magnetic coil is grounded.

Specifically, the aforementioned objects are achieved by a plasma processing apparatus comprising a vacuum container, a processing chamber arranged in the vacuum container and supplied with a processing gas, a holding electrode arranged in the processing chamber for holding the sample thereon, an electric field supply unit for supplying the electric field and a magnetic field supply unit for supplying the magnetic field to form a plasma in the space above the holding electrode in the processing chamber, and a grounded wall member making up the inner wall of the processing chamber above the holding electrode and having a cross section substantially in the shape of truncated cone, wherein the inner wall surface of the wall member is tilted along the magnetic lines of force due to the magnetic field supplied from the magnetic field supply unit.

Furthermore, the aforementioned objects are achieved by a plasma processing apparatus wherein the side wall surface of the processing chamber adjacent to and directly under a tabular member making up the ceiling surface of the processing chamber is substantially cylindrical, wherein the height of the cylindrical side wall surface is 20 mm to 30 mm and wherein the cylindrical surface of the side wall is formed of a plasma-resistant material.

In addition, the aforementioned objects are achieved by a plasma processing apparatus, wherein the angle of the inner wall surface approaches the vertical direction more, the nearer to the ceiling surface of the processing chamber, the apparatus further comprising an annular member formed of a conductive material arranged and grounded by surrounding the outer periphery of a sample table between the inner wall of the processing chamber and the sample table, and wherein the annular member is arranged in such a manner that the inner surface thereof in contact with the plasma is tilted downward of the holding electrode.

Other objects, features and advantages of the invention will become apparent from the following description of the embodiments of the invention taken in conjunction with the accompanying drawings.

### BRIEF DESCRIPTION OF THE DRAWINGS

FIG. 1 is a longitudinal sectional view schematically showing the configuration of the plasma processing apparatus according to an embodiment of the invention.

FIG. 2 is a longitudinal sectional view schematically showing the state of the magnetic field and the electric field due to the high-frequency power in the processing chamber of the plasma processing apparatus shown in FIG. 1.

FIG. 3 is a longitudinal sectional view schematically showing the configuration of a ring earth of the plasma processing apparatus shown in FIG. 1.

FIG. 4 is an enlarged view showing the detailed structure of the ring earth shown in FIG. 3.

### DETAILED DESCRIPTION OF EMBODIMENTS

A plasma processing apparatus according to this invention comprises a unit arranged in a vacuum container for supplying the electric field in UHF or VHF band not higher than 500 MHz into a processing chamber supplied with a gas, a coil for forming a magnetic field in the processing chamber, and a holding electrode, with a sample mounted thereon, arranged in the processing chamber and supplied with the high-frequency power, wherein the direction of the surface of the members in the processing chamber is tilted in accordance with the direction of the magnetic field thereby to reduce the contamination of the sample by the impurities and foreign matter due to the damage caused by the plasma, and this operation and effect are realized without adversely affecting the plasma generating performance and the process performance.

Embodiments of the invention are explained below with reference to the drawings.

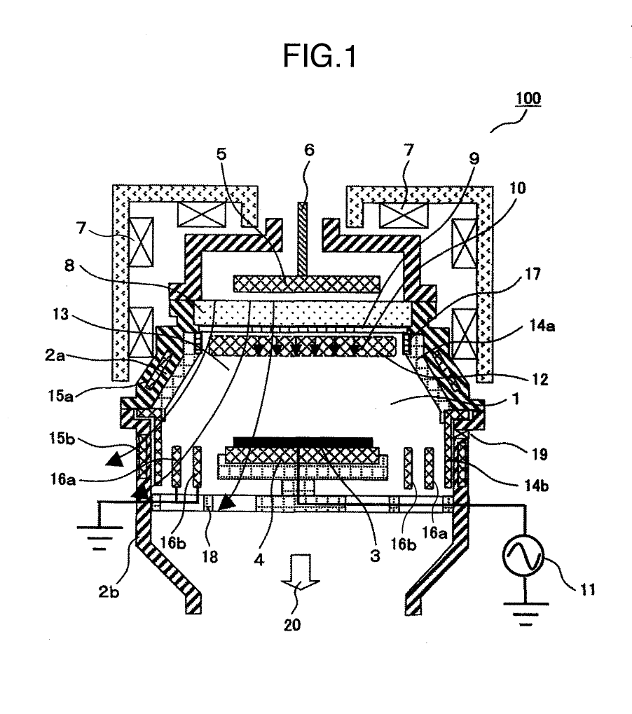

An embodiment of the invention is explained below with reference to FIGS. 1 to 4. FIG. 1 is a longitudinal sectional view schematically showing the configuration of a plasma processing apparatus according to an embodiment of the invention, and in particular, shows a plasma processing apparatus 100 to form the plasma in the processing chamber using a magnetic field.

In FIG. 1, the plasma used for processing is generated in a processing chamber 1 configured of an upper wall member 2a and a lower wall member 2b of the processing chamber 1 constituting a part of a vacuum container. The interior of the processing chamber 1 has a double structure, in which a side wall cover 14a is mounted on the inside of the upper wall member 2a and a side wall cover 14b on the inside of the lower wall member 2b in the area in contact with the plasma in the processing chamber 1.

The side wall covers 14a, 14b formed in contact with the plasma in the processing chamber 1 have a surface of aluminum alloy or the like, which is covered with a protective film resistant to the highly reactive plasma. The protective film is formed by treating the surface of the aluminum base material into alumite or by CVD or flame spray coating of a chemically stable compound (Al₂O₃, Y₂O₃, SiO₂, etc.). Further, heaters 15a, 15b for temperature control and a refrigerant pipe (not shown) are mounted on the walls of the upper wall member 2a and the lower wall member 2b of the processing chamber 1. Thus, the temperature of the side wall covers 14a, 14b in electrical and thermal contact with the heaters 15a, 15b can be controlled.

The electric field for generating the plasma in the processing chamber 1 is supplied to a discal antenna 5 arranged above and covering at least a part of the processing chamber 1 through a coaxial cable 6 arranged above the plasma processing apparatus 100. According to this embodiment, the frequency of the electric field is set to a predetermined range of UHF or VHF band not higher than 500 MHz.

In the magnetized plasma processing apparatus using a magnetic field of an ordinary microwave, the output of a multipurpose magnetron transmitter (frequency 2.45 GHz) is radiated into a discharge space from a microwave inlet. The incident microwave, propagating in the plasma generating chamber or the processing chamber, is absorbed under the condition in proximity to the magnetic field of 875 Gauss causing the ECR resonance.

The position of the ECR magnetic field at which resonance occurs is an important control parameter in the actual process or the cleaning discharge. The distance between this position and the sample is the parameter for adjusting the process state. In the case where the microwave is used, therefore, it is important to form the discharge space in a shape allowing the microwave to stably propagate therein. Also, in the ECR area where the electrons in the plasma are accelerated with high energy by the resonance effect, the side walls of the plasma generating chamber and the processing chamber in the vicinity of the ECR magnetic field are conspicuously damaged.

The manner in which microwave propagates in the processing chamber of the plasma processing apparatus using the microwave ECR is experimentally observed, and the result of measuring the spatial distribution of the electric field strength by three-dimensionally sweeping a compact electric field sensor mounted at the forward end of a measurement probe is reported in the thesis “Japan. J. Appl. Phys. Vol. 36 (1997) pp. 4617-4619”. According to this thesis, it has been confirmed that at the plasma density (electron density: ne=1×10¹¹ cm⁻³ or less) under the discharge conditions for actual etching, the microwave propagates to the sample holding electrode located at the lowest end of the processing chamber and forms the standing wave of a strong electric field.

In order to reduce the damage to the processing chamber, the electric field applied to generate the plasma is desirably absorbed into the plasma and the power used rapidly for generating the plasma. In forming a magnetized plasma, the absorption of the electric field into the plasma while propagating through the plasma is dependent on the propagation characteristic of the electric field. In the case where the frequency f (Hz) of the electric field is so low that Equation (4) below applies, the electric field is absorbed into the plasma before reaching the ECR magnetic field without propagating through the plasma (see the cited reference A. J. Lichtenberg: “PRINCIPLES OF PLASMA DISCHARGES AND MATERIALS PROCESSING”, JON WILEY & SONS, INC., p. 424).

In the case where Equation (4) applies, the propagation may be impossible even in an area where the magnetic field strength is weaker than in the ECR magnetic field. In the case of the microwave having the frequency of 2.45 GHz, for example, Equation (4) indicates that the propagation is possible with the electron density of not higher than 7.4×10¹⁰ cm⁻³. This well coincides with the result of the experiment described above.

In order to suppress the propagation of the unrequired electric field, therefore, the frequency of the electromagnetic wave is effectively required to be set at a low level. The lower the frequency, the more the propagation of such an electric field can be suppressed even for the low-density plasma. The density of the plasma used in the actual process depends on the object of the particular process. In the neighborhood of the wall of the processing chamber, for example, the plasma density is reduced to about one tenth, and therefore, the propagation of the unrequired electric field is required to be suppressed even at a sufficiently low density.

Electromagnetic wave frequency:

f(Hz)<fpe(Hz) (4)

where fpe is the plasma frequency (=9000 (n)^{1/2} Hz), and n the electron density (cm⁻³) of the plasma.

The power applied to the antenna 5 supplies the electric field of a predetermined frequency into the processing chamber 1 through a discal dielectric window 8 of a dielectric material such as quartz mounted above the processing chamber 1 and a discal gas shower plate 9 of a dielectric material arranged under the dielectric window 8 and having formed therein a plurality of gas feed holes for supplying the processing gas into the processing chamber 1. The magnetic field applied to the plasma is generated by a magnetic field coil 7 mounted around the outer periphery or the upper part of the processing chamber 1.

The processing gas required for generating the plasma is introduced to the upper part of the processing chamber 1 in the form of shower from several hundred gas feed holes formed in the gas shower plate 9 through the space arranged between the dielectric window 8 and the gas shower plate 9 and communicating with the gas feed holes. In the plasma generating area 12 constituting a part of the internal space of the processing chamber 1 immediately under the gas shower plate 9, the plasma 1 is generated in a manner that the electric field radiated from the antenna 5 is propagated within the processing chamber while being partially absorbed within the chamber.

A wafer 3 providing a sample to be processed is mounted on the wafer holding electrode 4 in the lower part of the processing chamber 1. The wafer holding electrode 4, holding by adsorbing the wafer 3 by static electricity and controlling the temperature of the wafer 3 at the same time, supplies the high-frequency power from the high-frequency power supply 11 to the electrode member of a conductive material in the wafer holding electrode 4. The resulting electric field is applied to the wafer 3, and by changing the radiation energy of the charged particles from the plasma, the process is adjusted. The high-frequency power applied to the wafer 3 from the high-frequency power supply 11 is several hundred kHz to several MHz and lower in frequency than the power used for generating the plasma.

This is by reason of the fact that the application of the high-frequency power is intended to induce ions of large mass from the plasma and etch the surface film of the wafer 3 accurately with a high aspect ratio, and that ions can be induced at a low frequency. For the frequency not lower than 10 MHz, on the other hand, the applied high frequency power is consumed for plasma generation thereby adversely affecting not only the plasma generating efficiency but also the processing efficiency.

The height of the plasma generating area 12 is set in accordance with the distance before the absorption of the radio wave, and dependent on the radio wave frequency. In the case where the electromagnetic wave for plasma generation is so low in frequency that it cannot propagate through the plasma, the electric field strength of the electromagnetic wave incident to the plasma exponentially decreases in the plasma. Thus, the electromagnetic wave is usually absorbed after advancing by the surface layer depth δ. The surface depth δ is approximately expressed as δ=(m/2² μ₀n)^{1/2} in the case where the electromagnetic wave frequency (f) is larger than the collision frequency (ν) between electrons and neutral gas (2πf [symbol] ), where m is the electron mass, e the elementary electric charge and μ₀ the magnetic permeability.

In the case where the electron density of the plasma is 1×10¹¹ cm⁻³, the surface layer depth δ is 16 mm. This indicates that the incident electromagnetic wave starting to propagate is absorbed into the plasma while propagating over the distance of about 16 mm in surface layer depth. In other words, the electromagnetic wave exists and propagates up to about 16 mm from the electromagnetic wave inlet. Over the distance of about the surface layer depth (about 30 mm or less) from the inlet window, therefore, the geometric change of the side wall of the processing chamber is minimized to suppress the change in the propagation characteristic of the electric field for the purpose of effectively preventing the disturbance of the electromagnetic wave mode distribution and the plasma distribution. According to this embodiment, the plasma generating area 12 is defined by a substantially cylindrical member. Especially, the angle of the inner wall surface of the processing chamber 1 including the plasma generating area 12 is configured to change more toward the vertical direction, the nearer to the ceiling surface of the processing chamber 1.

Also, the plasma in the upper part of the processing chamber 1 into which the electric field is introduced from the dielectric window 8 and the gas shower plate 9 is high in energy, so that the inner wall of the processing chamber 1 is sputtered with high energy thereby to cause considerable chemical damage due to the reactive gas. To cope with this problem, the side wall of the upper part of the processing chamber 1 where the plasma of high energy with a strong electric field is liable to propagate is effectively protected by a plasma-resistant material (quartz, Y₂O₃ or the like ceramic).

In the case where the whole inner surface of the processing chamber 1 is covered up with a plasma-resistant material such as quartz, however, the function of the inner wall of the processing chamber 1 as an earth electrode would be reduced against the high-frequency power applied to the wafer holding electrode 4. Therefore, the area of the inner wall to be covered with the plasma-resistant material should be as small as possible. According to this embodiment, the frequency of the power for generating the plasma is set to as low as not higher than 500 MHz, so that the propagation of the electric field is limited to the upper part of the processing chamber 1. Thus, the area of the inner wall protected against the high-energy electrons is only about 30 mm in length of the side wall in the upper part of the processing chamber 1 immediately under the gas shower plate 9. In this way, the earth area against the high-frequency power applied to the wafer 3 is reduced.

The height of the plasma generating area 12 according to this embodiment is equivalent to the distance before absorption of the electromagnetic wave and about 30 mm. In the plasma generating area 12, the strength of the electric field for plasma generation is high and so is the electron energy. Therefore, the part 20 mm to 30 mm in length from the upper end of the uppermost cylindrical portion of the side wall cover 14a in contact with the high-energy electrons is protected by the plasma-resistant material 17. As a replacement of the plasma-resistant material 17, a ring of a chemically stable material such as quartz several mm thick or a protective film about 200 μm thick may be applied by flame spray coating to the side wall cover 14a to further increase the thickness of the portion corresponding to the plasma-resistant material 17.

Also, according to this embodiment, the magnetic lines of force 13 are progressively dispersed downward from the ceiling portion of the processing chamber 1 so that the plasma 1 generated in the ceiling surface of the processing chamber 1 is dispersed toward the wafer thereunder while being enlarged in stable fashion along the magnetic lines of force 13 generated in the magnetic field coil 7. In the process, the inner surface of the side wall cover 14a is arranged substantially parallel to the direction of the magnetic lines of force 13. In this way, the disturbance of the plasma flow along the magnetic lines of force 13 is suppressed and the process stabilized.

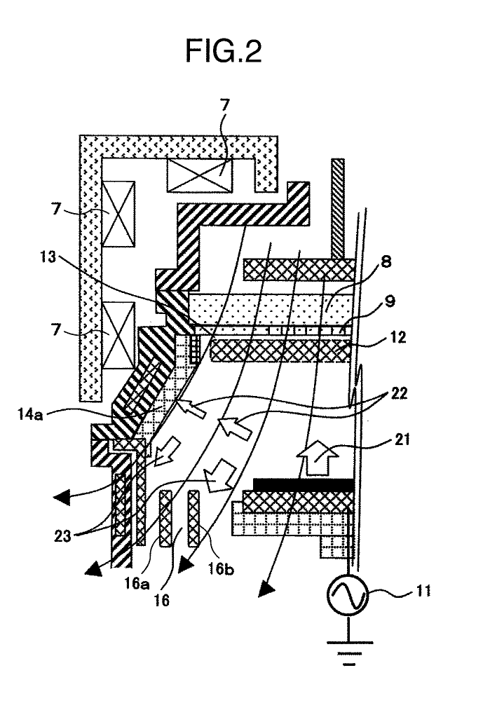

Now, the propagation behavior of the high frequency power applied to the wafer 3 is explained with reference to FIG. 2. FIG. 2 is a longitudinal sectional view schematically showing the state of the magnetic field and the electric field generated by the high-frequency power in the processing chamber of the plasma generating apparatus according to the embodiment shown in FIG. 1.

In the magnetized plasma processing apparatus, the plasma generated mainly in the plasma generating area 12 is restricted by the magnetic lines of force 13 while being moved and dispersed downward along the direction of the magnetic lines of force 13. The degree to which the plasma is restricted by the magnetic lines of force is evaluated by Equations (1), (2). In respect of the standard plasma parameters, the mobility and the dispersion coefficient are suppressed to 1/5200 in the direction across the magnetic lines of force 13 in the magnetic field of 100 Gauss.

Similarly, with regard to the high-frequency power of about several hundred kHz applied to the wafer 3, the current due to the high-frequency power flows toward the ring earth 16 and the side wall cover 14a functioning as the earth. This current 21 from the wafer 3 contains a current component 22 flowing in the direction across the magnetic lines of force 13 and a current component 23 flowing in the direction along the magnetic lines of force 13. The current 23 flowing along the direction of the magnetic lines of force 13, free of the restriction by the magnetic lines of force 13, flows with a low impedance and is great in amount, while the current 22 flowing across the magnetic lines of force 13 is small in amount.

As a result, the potential difference in the plasma attributable to the high-frequency power, though small in the direction along the magnetic lines of force 13, is large in the direction across the magnetic lines of force 13. By arranging the grounded side wall cover 14a in proximity and parallel to the magnetic lines of force 13, therefore, the potential difference due to the high frequency power between the side wall cover 14a and the plasma can be less varied from one point to another on the side wall cover 14a, with the result that the sputtering and cut due to ions are distributed over the whole surface facing the plasma.

Assuming that the inner surface in the shape of a truncated cone of the side wall cover 14a facing the plasma crosses the magnetic lines of force 13 (or the isodynamic plane or a contour of the magnetic field density), the potential difference due to the high-frequency power on the side wall cover 14a crossing the magnetic lines of force 13 near the wafer 3 would be increased, and the damage by the ion sputter is accelerated at the particular point, thereby shortening the life of the related parts. The side wall cover 14a, which functions as the earth against the high frequency power, cannot be formed with a thick protective film on the surface of the base material of aluminum or the like. The protective film is an alumite film about several tens of μm thick or a plasma-resistant ceramic spray coating about several hundred μm thick. In the case where the ion sputter is concentrated, therefore, the base material would be exposed, and the material of the base material together with the heavy metal contents thereof would be released as a contaminant into the processing atmosphere. Also, the minor heavy metal contained in the protective film would constitute a source of contamination.

According to this embodiment, in contrast, this problem is obviated by arranging the inner surface of the side wall cover 14a substantially in parallel to the direction of the magnetic lines of force 13 and thereby suppressing the disturbance of the plasma flow along the magnetic lines of force 13.

In the case where the interior of the processing chamber 1 is cleaned or the consumable parts thereof changed, the interior of the processing chamber 1 is exposed to the same pressure as the atmospheric pressure, after which the upper member 2a and the lower member 2b of the processing chamber 1 can be separated from each other at the upper and lower connecting ends thereof. Then, the upper member 2a and the side wall cover 14a arranged and held on the inside thereof are moved up integrally with the dielectric window 8 located above, so that the interior of the processing chamber 1 becomes accessible. For the purpose of maintenance, inspection or adjustment of the antenna 5, on the other hand, both the magnetic field coil 7 and the antenna 5 or the magnetic field coil 7 alone can be moved up by a vertical moving unit such as a crane.

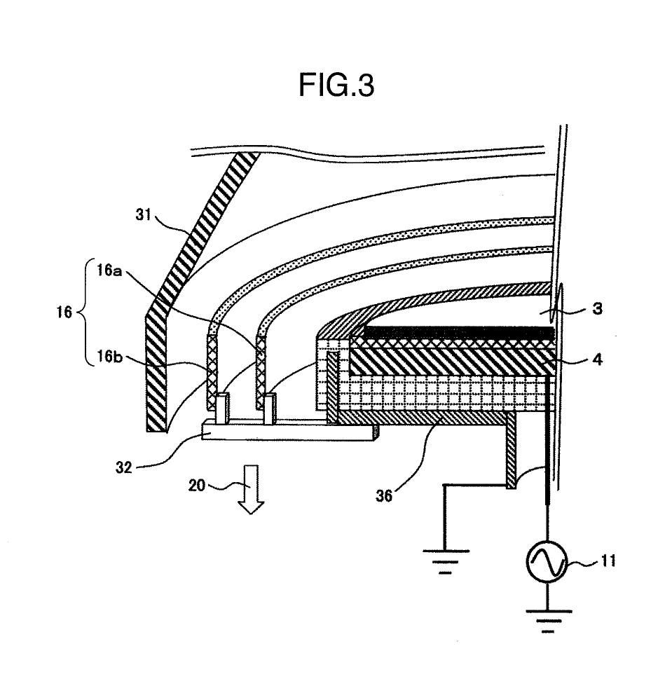

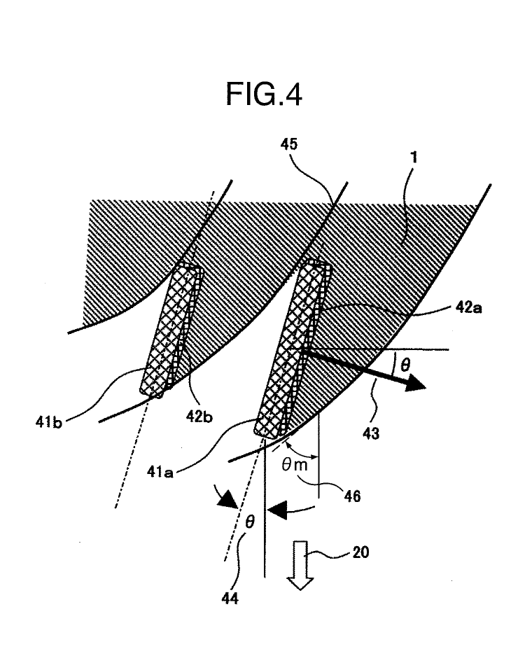

Also, a ring earth 16 configured of a grounded annular conductive member is arranged, in the space constituting a path for discharging the plasma, the processing gas and the reaction products formed in accordance with the process downward, between the outer periphery of the wafer holding electrode 4 and the upper wall member 2a or the lower wall member 2b of the processing chamber 1. The ring earth 16 acts as an earth electrode against the high-frequency power supplied to the wafer holding electrode 4. The ring earth 16 is explained below with reference to FIGS. 3 and 4.

The ring earth 16 is arranged in proximity to the tail of the exhaust port 20 of the whole processing chamber 1 located under the wafer holding electrode 4, so that the products of the ion sputtering by the high-frequency power are easily discharged directly and the contamination of the wafer 3 reduced. The surface of the ring earth 16 is covered by a protective film of a plasma-resistant material.

FIG. 3 is a longitudinal sectional view schematically showing the configuration of the ring earth according to the embodiment shown in FIG. 1. In FIG. 3, the ring earth 16 is configured of a member of a conductive material such as aluminum and has the surface thereof coated with a film of a plasma-resistant material such as alumite or covered by a flame spray coating of a plasma-resistant ceramic such as yttria. The ring earth 16 has a wide area in contact with the plasma to increase the effect as an earth electrode, and in order not to reduce the exhaust conductance, is formed of a plurality of small interconnected cylindrical members 16a, 16b which are located under the wafer-mounting surface of the wafer holding electrode 4 with the wafer 3 mounted thereon and have such a height as to surround the outer periphery of the wafer-mounting surface of the wafer holding electrode 4.

The shape of the ring earth 16, not limited to a cylinder but arbitrary, may be a taper or a multiplicity of strips arranged in peripheral direction. Also, the ring earth 16 is supported and connected while maintaining the electrical conductivity using a beam-like conductive member 32 and a metal screw, etc. supported and coupled to the lower part of the wafer holding electrode 4. As a result, the ring earth 16 is grounded through an earth conductor 36 arranged under the wafer holding electrode 4. The ring earth 16, though connected to the grinding conductor 36 of the wafer holding electrode 4 according to this embodiment, may alternatively be connected to and grounded through the grounded side wall 31 of the processing chamber constituting a part of the upper wall member 2a or the lower wall member 2b of the processing chamber.

The angle (direction of the side wall of the cylindrical member) at which the ring earth 16 is arranged and the length of the ring earth 16 are explained with reference to FIG. 4. FIG. 4 is a diagram schematically showing, in an enlarged form, the arrangement of the ring earth shown in FIG. 3.

The plasma generated in the upper part of the processing chamber 1 is restricted by the magnetic lines of force while being dispersed toward the ring earth 16 at a lower position. Thus, the plasma density is increased on the surface of the ring earth 16 where the dispersed plasma flows in, and the sheath is formed on this particular surface. The high-frequency current generated by the electric field due to the high-frequency power applied to the wafer 3 also flows in from the sheath in contact with the high-density plasma.

In the schematic diagram shown in FIG. 4, a plurality of cylindrical members 41a, 41b of the ring earth 16 are arranged with the plasma-influent surface thereof tilted at a predetermined angle θ toward the center of the processing chamber 1 in such a manner that the upper part of the ring earth 16 is nearer than the lower part thereof to the wafer holding electrode 4 arranged at the central part of the processing chamber 1 on the right side in FIG. 4, while at the same time crossing, at different predetermined angles, the magnetic lines of force 45 flowing from upper right part to lower left part. Sheaths 42a, 42b are formed on the surface of the cylindrical members 41a, 41b facing the plasma moving toward the lower outer periphery of the processing chamber 1 in the form dispersed along the direction of the magnetic lines of force, i.e. in FIG. 4, on the right and upper sides of the rectangular section of the cylindrical members 41a, 41b.

In the process, the potential difference is formed in the sheaths 42a, 42b in accordance with the frequency of the electric field, by which the ions in the plasma are accelerated and sputtered by colliding with the surfaces of the cylindrical members 41a, 41b. At the same time, the products are released mainly in the sputter direction 43 perpendicular to the surface of the cylindrical members 41a, 41b and at an angle θ to the horizontal direction.

In order to prevent the foreign matter from attaching to the wafer 3 due to the aforementioned products or the products from being dispersed into the upper plasma and adversely affecting the distribution and the processing of the material in the plasma, the inner peripheral surface of the cylindrical members 41a, 41b of the earth ring 16 by way of which the plasma flows in is tilted by the tilt angle 44 (θ) in the direction of evacuation in the processing chamber 1 or toward the lower exhaust port 20 thereby to set the sputter direction 43 toward the exhaust port 20 and thus facilitate the discharge of the products.

In the case where the tilt angle 44 assumes, progressively downward of the processing chamber 1, a value nearer to the tilt angle 46 (θm) of the magnetic lines of force 45 flowing toward the outer periphery, however, the cylindrical members 41a, 41b having a rectangular section and the magnetic lines of force 45 would become substantially parallel to each other. Then, the area of the cylindrical members 41a, 41b exposed to the magnetic lines of force 45 would be reduced, and so the area of the earth electrode against the plasma. As a result, the plasma potential is instabilized and the process is adversely affected. According to this embodiment, therefore, the tilt angle 44 (θ) is set in the range of 0 to the angle 46 (θm) with respect to the horizontal direction. With this configuration, the surface of the cylindrical members 41a, 41b exposed to the plasma crosses the isodynamic plane of the magnetic lines of force 45, thereby making it possible to secure the area of the earth electrode in contact with the plasma.

The cylindrical members 41a, 41b have the function to suppress the unnecessary dispersion of the plasma toward the exhaust side as well as the function as an earth grounded against the plasma. The ring earth members 41a, 41b are located midway of the exhaust path of the plasma and the products dispersed and evacuated downward of the processing chamber 1, and therefore, required to be of such a shape that the exhaust efficiency is not necessarily reduced.

The magnetized plasma, as shown in FIG. 4, flows along the magnetic lines of force 45, and therefore, can be prevented from flowing downward by setting the minimum length of the earth, the position and the shape in which the magnetic lines of force 45 cross the plane of the cylindrical members 41a, 41b as an earth in contact with the plasma.

According to this embodiment, the frequency of the power supplied to form the plasma is set in the range of UHF or VHF band not higher than 500 MHz. As compared with the related art, therefore, the propagation of the electric field is suppressed to not higher than 3×10⁹ cm³ which is as low as about 1/20. Under a high gas pressure, therefore, the plasma is efficiently absorbed without unnecessary propagation of the electric magnetic field even in the plasma area (density about 3×10⁹ cm⁻³) around the processing chamber 1. As a result, the consumption of the wall member of the processing chamber 1 facing the plasma which otherwise might be caused by the propagation of the surrounding electric field into the plasma is reduced.

The plasma generated in the upper part of the processing chamber 1 is conveyed downward along the magnetic lines of force 13 due to the magnetic field coil 7. By forming the side wall of the processing chamber 1 facing the plasma in parallel to the magnetic lines of force, therefore, not only the plasma flow is not hampered but also the charged particles in the plasma are prevented from being concentrated at a specified portion of the grounded side wall member thereby to locally scrape off or develop foreign matter. Thus, the intervals at which the parts are changed can be lengthened for an improved availability of the plasma processing apparatus 1.

Further, in the case where the wafer 3 is processed while applying the electric field due to the high-frequency power thereto, the inner wall of the processing chamber 1 facing the plasma above the wafer 3 is formed substantially in parallel to the magnetic lines of force 13. Thus, the high-frequency current flows uniformly into the surface of the wall member of the processing chamber 1 acting as the earth against the high-frequency power. As a result, the voltage of the sheath due to the high-frequency power formed on the inner wall surface of the processing chamber 1 facing the plasma is flattened, and the effect of damage to the wall member by the ion sputtering is distributed uniformly, thereby making it possible to lengthen the intervals at which the inner wall of the processing chamber 1 is replaced.

Also, in order to generate the plasma in stable manner under a low density on a large-area wafer 3, the plasma is generated in stable manner and with high density in the plasma generating area 12 defined by the substantially cylindrical member arranged at the uppermost part of the processing chamber 1, and the high-density plasma thus generated is stably dispersed downward of the processing chamber 1 by the magnetic field due to the magnetic field coil. Further, in view of the fact that the change in the sectional shape of the side wall, constituting the plasma generating area 12, immediately under the ceiling surface member of the processing chamber 1 is suppressed by approximating the particular side wall to the vertical direction, the disturbance of the electric field supplied is suppressed and the plasma is generated in stable fashion. Furthermore, the upper wall member 2a or the inner wall of the side wall cover 14a of the processing chamber is formed in the shape of a truncated cone in such a manner that the inner diameter of the processing chamber 1 is progressively increased downward from the ceiling thereof. Thus, the plasma is dispersed in stable manner, thereby reducing the generation of local foreign matter while at the same time making it possible to process uniformly and stably the wafer 3 located at a lower position.

Also, since the processing chamber 1 is formed in the shape of a truncated cone, the space between the wafer 3 and the side wall cover 14a, the upper wall member 2a or the lower wall member 2b in the lower part of the processing chamber 1 is enlarged for an improved exhaust conductance. Thus, the impurities or foreign matter which may be generated from the inner wall of the processing chamber 1 are easily discharged and the contamination of the wafer 3 reduced.

Further, a substantially cylindrical (annular) electrode is grounded at a position surrounding the outer periphery of the wafer holding electrode 4 while keeping a predetermined distance from the wafer 3, in the space between the wafer 3 in the lower part and the side wall of the processing chamber 1. This electrode functions, therefore, as an earth electrode against the high-frequency electric field applied to the wafer 3, and the total earth area including the side wall of the processing chamber 1 is enlarged. Thus, the sheath potential difference of the earth electrode is reduced and so is the damage to the side wall due to the ion sputtering.

Also, the earth electrode arranged in the neighborhood of the wafer 3 is relatively near to the wafer 3 to which the high-frequency power is applied. Therefore, the high-frequency power easily flows into the earth electrode, and the earth electrode is easily subjected to the effects of the ion sputtering. In view of the fact that the earth electrode is located downstream of the processing chamber 1 in the direction of evacuation under the wafer 3, however, the contamination of the wafer 3 is suppressed. Further, the surface of the earth electrode crosses the isodynamic plane of the magnetic lines of force for dispersing the plasma and the surface thereof in contact with the plasma is tilted toward the exhaust port 20 downward. Therefore, the substances discharged by sputtering from the surface of the earth electrode are easily evacuated and the contamination of the wafer 3 prevented.

It should be further understood by those skilled in the art that although the foregoing description has been made on embodiments of the invention, the invention is not limited thereto and various changes and modifications may be made without departing from the spirit of the invention and the scope of the appended claims.

1. A plasma processing apparatus comprising:
a vacuum container;
a processing chamber arranged in the vacuum container and supplied with a processing gas;
a holding electrode arranged in the processing chamber for holding a sample to be processed, on the upper surface thereof;
an electric field supply unit for supplying an electric field and a magnetic field supply unit for supplying a magnetic field to form the plasma in the space above the holding electrode in the processing chamber; and
a grounded wall member making up the inner wall, substantially in the shape of a truncated cone, of the processing chamber above the holding electrode.

2. A plasma processing apparatus according to claim 1,
wherein the inner wall surface of the wall member is tilted along the magnetic lines of force due to the magnetic field supplied from the magnetic field supply unit.

3. A plasma processing apparatus according to claim 1,
wherein the side wall surface of the processing chamber immediately under and adjacent to a tabular member making up the ceiling surface of the processing chamber is substantially cylindrical.

4. A plasma processing apparatus according to claim 3,
wherein the height of the substantially cylindrical side wall surface is in the range of 20 mm to 30 mm.

5. A plasma processing apparatus according to claim 3,
wherein the substantially cylindrical side wall surface is formed of a plasma-resistant material.

6. A plasma processing apparatus according to claim 1,
wherein the angle of the inner wall surface is configured to change more toward the vertical direction, the nearer to the ceiling surface of the processing chamber.

7. A plasma processing apparatus according to claim 1, further comprising:
an annular member arranged around the outer periphery of a sample table between the inner side wall of the processing chamber and the sample table and formed of a grounded conductive member.

8. A plasma processing apparatus according to claim 7,
wherein the inner surface of the annular member in contact with the plasma is tilted downward of the holding electrode.
